(19) United States
(12) Patent Application Publication
(10) Pub. No.: US 2009/0099946 A1
(43) Pub. Date: Apr. 16, 2009

(54) Methods and systems for valuing embedded options

(76) Inventor: Sean Kelley, Oak Park, IL (US)

Correspondence Address: BUCHANAN, INGERSOLL & ROONEY PC, POST OFFICE BOX 1404, ALEXANDRIA, VA, 22313-1404, US

(21) Appl. No.: 11/907,686

(22) Filed: Oct. 16, 2007

(51) Int. Cl. G06Q 40/00

(52) U.S. Cl. 705/35

(57) ABSTRACT

Methods and systems are disclosed for valuing a financial obligation having an embedded option. The method includes determining a value of the embedded option, converting the embedded option value to a target basis representing the yield difference between the financial obligation having the embedded option and a corresponding financial instrument without an embedded option, determining an actual basis between the financial obligation and the corresponding financial instrument; and determining a current value of the financial obligation based on the difference between the target basis and the actual basis.

### FIELD

The present disclosure relates generally to valuation of financial obligations having embedded options.

### BACKGROUND

Current valuation techniques poorly estimate the value of discounts and premiums of financial obligations, such as leveraged loans, that include embedded options. For lack of a better technique, many valuators recognize that leveraged loans historically are repaid (e.g., refinanced) within two years of being issued, rather than being paid at the stated maturity date of the loan. Some value the relative return of leveraged loans simply by dividing the premium or discount of each loan by the historical duration and subtracting or adding the result to the stated interest rate spread of each respective loan. Others improve on this technique by reducing the historical duration as the loan ages by tracking the frequency at which loans are refinanced or monetized, and/or by having a policy to sell holdings on a certain date after the loan closes.

### SUMMARY

The present disclosure provides exemplary systems and methods for determining the value of an embedded option associated with the financial obligation. The exemplary methods and systems determine a value of the embedded option, convert the embedded option value to a target basis representing the yield difference between the financial obligation having the embedded option and a corresponding financial instrument without an embedded option, determine an actual basis between the financial obligation and the corresponding financial instrument, and determine a current value of the financial obligation based on the difference between the target basis and the actual basis. The systems and methods can also value loan covenants as embedded put options held by a lender.

### BRIEF DESCRIPTION OF THE DRAWINGS

FIG. 1 is a block diagram illustrating an exemplary system environment as disclosed herein;

FIG. 2 is a flow chart illustrating an exemplary method for determining the value of options embedded in leveraged senior loans, as disclosed herein;

FIG. 3 is a block diagram illustrating an exemplary system for performing the method disclosed herein;

FIG. 4A is a chart illustrating exemplary spreads; and

FIG. 4B is a chart illustrating exemplary prices determined from exemplary spreads.

FIG. 4C is a chart illustrating exemplary times of embedded option exercise; and

FIG. 4D is a chart illustrating exemplary option exercise frequencies.

### DETAILED DESCRIPTION

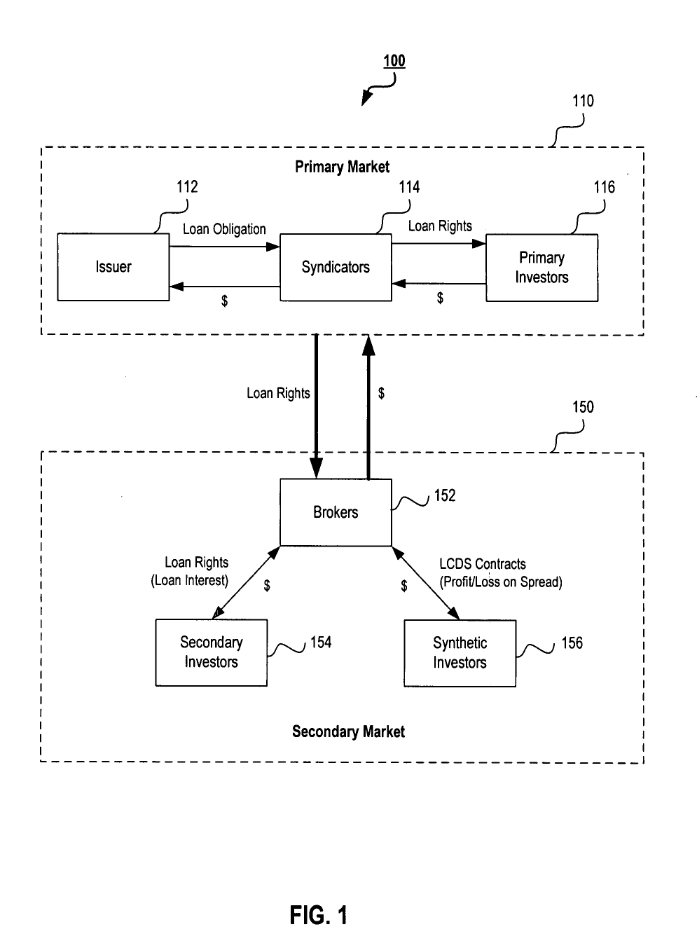

FIG. 1 is a block diagram illustrating an exemplary environment 100 in which the method of the present disclosure may be performed. Environment 100 has a primary market 110, including an issuer 112, syndicators 114, and primary investors 116. In addition, environment 100 has a secondary market 150, including secondary investors 154 and synthetic investors 156.

In a brief overview of exemplary environment 100, issuer 112 may need to issue a leveraged loan to obtain capital for its operations and/or acquisitions. Syndicators 114 service issuer 112's need by acquiring funds to finance the loan by selling rights to the loan to investors. The loan rights are essentially a right to a respective portion of the total value of the leveraged loan's total value. Once sales of loan rights in the primary market 110 are completed (i.e., closed), the rights can be sold to investors in secondary market 150, where they can be traded like securities.

More specifically, in the primary market 110, syndicators 114 underwrite a leveraged loan for issuer 112. Primary market 110 encompasses the financial relationships involved in originating a leveraged loan obligation. Issuer 112 may be one or more individuals, businesses or other legal entities that develops and sells securities and other financial obligations for the purpose of financing its operations. Issuer 112, for example, may be a domestic or foreign government, corporation, investment trust or special purpose vehicle. In the exemplary embodiment below, the financial obligation is a leveraged loan obligation.

A leveraged loan is a financial obligation issued by an entity, such as issuer 112, which is considered speculative in comparison to investment-grade obligations. For instance, a leveraged loan may be one having a BB, B or lower bank loan rating, and/or a spread of over 125 basis points. In other words, a leveraged loan is a financial obligation that is more likely to default due to the inability of issuer 112 to make required payments on the loan debt. An issuer 112 may issue a leveraged loan to raise capital when, for example, it does not have sufficient credit quality to obtain capital through an investment-grade obligation, or if it chooses to maintain a more aggressive capital structure with the goal of increasing equity returns.

The leveraged loan may be funded by syndicators 114. By funding a loan through a syndicate of lenders, issuer 112 can access a much greater pool of money than could be acquired from a single source. In addition, splitting the loan amongst a number of syndicators 114 allows the syndicators 114 to spread the risk of issuer 112's potential default.

Syndicators 114 can be a group of individuals, companies or other entities that administer the issuance and distribution of issuer 112's loan to primary investors 116. Syndicators 114 may, for example, deal with one or more primary investors 116 to obtain their commitments before the loan is issued to ensure a market for the loan and if the rights of the loan are not fully sold after issuance, syndicators 114 may be obligated to purchase the unsold rights. For their part, syndicators 114 can receive underwriting fees from the issuer 112, as well as earning revenue by selling the underwritten instruments to primary investors 116.

Primary investors 116 may be individuals, businesses or other legal entities that purchase the leveraged loan from syndicators 114. Primary investors 116 may be, for example, banks, mutual funds, managed accounts, insurance companies or special purpose vehicles. In return for purchasing a loan obligation from syndicators 114, each primary investor receives one or more rights of the loan obligation which include earning interest on the loan and voting regarding changes in the loan.

The primary investors 116 may invest in leveraged loans to achieve a greater return on investment than investment-grade securities, albeit at a greater risk. The higher default frequency of issuer 112, however, can be mitigated by a security interest in the assets of the company (i.e., “issuer 112”). Accordingly, primary investors 116 can also have the right to recover from issuer 112's assets in case issuer 112 defaults on the loan. In some cases, the leveraged loan grants a senior interest in the issuer 112's assets such that, in case of default, holders of rights of the loan have the right to recover their losses before other creditors having a non-senior interest in the assets. Such loans are so-called “leveraged senior loans.” As such, leveraged loans can offer primary investors 116 less risk in case of default than other speculative-grade investments.

Secondary market 150 includes the relationships between entities who trade in rights to the loan after the loan is closed in the primary market 110 and sold (to the extent possible) from syndicators 114 to primary investors 116. Primary investors 116 and/or syndicators 114 can trade rights of the loan obligation obtained in the primary market 110 with investors in the secondary market 150.

As shown in FIG. 1, secondary market 150 can include brokers 152, secondary investors 154 and synthetic investors 156. Brokers 152 may be individuals, business or other entities that facilitate the trade of loan obligations in the secondary market 150 by, for example, negotiating and executing contracts for the sale of loan rights and/or associated contracts. Although brokers 152 are shown in FIG. 1 as a separate entity, brokers 152 may be any entity, including syndicators 114, primary investors 116, secondary investors 154 or synthetic investors 156.

Secondary investors 154 are individuals, businesses or other entities that deal in the secondary market 150 by buying and/or selling rights of the loan obligation. Such investors may also be primary investors 116. For instance, secondary investors 154 may be a bank that purchases rights representing an assignment or participation in the loan in exchange for a portion of the loan's benefits, including interest revenue and rights to vote on any changes in the loan's conditions (e.g., covenants).

Synthetic investors 156 are entities that deal in the secondary market 150 by buying or selling loan-only credit default swap (LCDS) contracts corresponding to the leveraged loan. Generally, a credit default swap (CDS) resembles an insurance agreement designed to transfer the credit risk of fixed income products between parties. In a credit default swap (CDS), two counterparties agree to isolate and separately trade the credit risk of at least one third-party reference obligation (e.g., a bond). Under a credit default swap agreement, a protection buyer pays a periodic fee to a protection seller in exchange for a contingent payment by the seller when the reference entity triggers a credit event (such as bankruptcy, failure to pay or, in some agreements, modified restructuring of a debt obligation). After a credit event, the protection seller either takes delivery of a defaulted (deliverable) obligation for the par value (physical settlement) or pays the protection buyer the difference between the par value and recovery value of the obligation (cash settlement). The cash settlement procedures are typically defined in the credit default swap agreement and involve obtaining price quotes on a deliverable obligation from a prescribed number of nationally recognized security dealers.

Loan-only credit default swaps (LCDS) are a type of credit default swap derived from leveraged loan obligation. However, unlike a typical credit-default swap, the underlying protection is sold on leveraged loans of a reference entity rather than the broader category of bonds or loans. A “synthetic” financial instrument is one that is created to simulate another instrument with the combined features of a collection of other assets. For example, you can create a synthetic stock by purchasing a call option and simultaneously selling a put option on the same stock. The synthetic stock would have the same capital-gain potential as the underlying security. In secondary market 150, a LCDS enables an investor to “synthetically” buy a loan by going short the LCDS or sell a loan by going long the LCDS.

In addition, a primary or secondary investor can hedge by buying a LCDS corresponding to the loan obligation. Moreover, unlike a secondary investor that buys a loan assignment and participation, which are long-only markets based on the duration of the underlying loan term, the LCDS purchase may allow a synthetic investor 154 to buy protection on a loan that the investor doesn't hold. If the loan defaults, the synthetic investor 154 can purchase the loan in the secondary market 150.

The values of rights of the leveraged loan and the corresponding LCDS in the secondary market 150 vary based on a number of factors, including changes in credit spread. Generally, issuer 112 must compensate investor 154 for accepting default risk. A financial obligation with zero risk would pay the investor the risk-free rate. The risk-free rate represents the interest an investor would expect from an absolutely risk-free investment over a specified period of time. In theory, the risk-free rate is the minimum return an investor expects for any investment since he would not bear any risk unless the potential rate of return is greater than the risk-free rate. In practice, however, the risk-free rate does not exist since even the safest investments carry a very small amount of risk. Thus, the interest rate on a three-month U.S. Treasury bill or the three-month London Inter-bank Offering Rate (LIBOR) often serves as risk-free approximations.

To hold any risky debt instrument, including leveraged senior loans, investors (such as secondary investor 154) can demand a return in excess of the risk-free rate to compensate for greater expected losses. The riskier the loan, the larger the credit spread required to clear the market. Since investors will generally demand more compensation as perceived risk increases, the premium size will change over time, holding credit risk constant. As the prevailing credit spread for a given risk-level fluctuates, previously-issued loans will have credit spreads higher or lower than the credit spread on a new issue loan with similar perceived risk.

The market price of a leveraged senior loan changes to compensate the investors for differences between the stated credit spread on the loan and the prevailing credit spread of a new loan issue having similar credit risk. Such credit-risk cohorts often follow broad rating categories as reported by one or several statistical rating organizations, such as Standard & Poor's or Moody's.

A leveraged loan effectively includes an embedded call option due to the fact that issuer 112 may repay the loan before its maturity date (usually five to eight years). A call option represents a contract sold by one party to another party providing the buyer the right, but not the obligation, to buy a security or other financial obligation at an agreed-upon price (i.e., “strike price”) during a certain period of time or on a specific date (exercise date). Options can be used in secondary market 150 many different ways; for instance, investors may use options for investments (i.e., speculation), or reduce the risk of holding an asset (i.e., hedging).

Because the LCDS are derived from leveraged loan rights, an LCDS and its corresponding loan rights vary based on the same factors. As such, the relative value of the two should be essentially equivalent. However, unlike the leverage loan rights, the LCDS does not include an embedded call option. Thus, by valuing the embedded call option in the leveraged loan rights, the relative difference in value between the loan rights and the LCDS may be predicted.

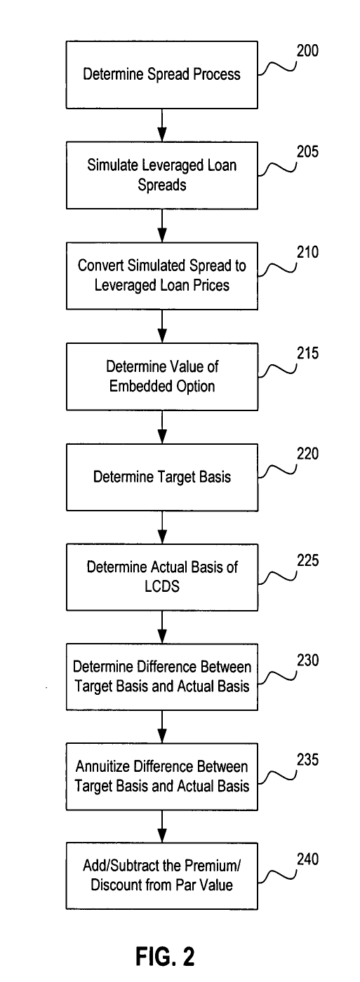

FIG. 2 is a flowchart illustrating an exemplary method for valuing a leveraged loan given the corresponding LCDS premium of the same issuer. The exemplary method includes determining a value of the embedded option, converting the embedded option value to a target basis representing the yield difference between the financial obligation having the embedded option and a corresponding financial instrument without an embedded option, determining an actual basis between the financial obligation and the corresponding financial instrument, and determining a current value of the financial obligation based on the difference between the target basis and the actual basis.

As noted above, the call option embedded in a leveraged loan exists because issuer 112 has the option to payoff the leveraged loan at par value at any time before the loan's maturity. In some embodiments, the value of the call option can be determined by applying the Longstaff-Schwartz algorithm to a “Monte Carlo” simulation, also known as “least-squares Monte Carlo” (LSM) process. In the case of options, the least-squares Monte Carlo is advantageous because it considers mean-reversion and non-normal distributions without biased continuation values.

Alternatively, the value of the option can be otherwise estimated using any of various techniques known in the art. For instance, a partial differential equation that predicts the credit spread of the leveraged loan can be determined through an arbitrage-free pricing model, similar to the Black-Scholes equation for pricing equity options. In addition, historical price volatility of the leveraged senior loan can be used to construct a “binomial tree” with discrete-time nodes representing potential loan price paths and corresponding intrinsic option values that can be discounted to the present and averaged to obtain the option price.

To apply the least-squares Monte Carlo technique to price an embedded option, it is first determined by what process the option price changes over time. (Step 200.) Financial instruments, such as leveraged loans follow a historical price sequence denoted as its price “process.” Some prices follow directly from other financial instruments or economic data and thus can be described by other processes. When an equity price increases, for example, the price of the derivative call option also increases, holding other factors constant. In other instances, a data processing system generates an algorithm indicative of a pattern in historical data.

The embedded call option in leveraged senior loans follows from the corresponding leveraged loan price, which in turn varies with respect to the credit spread. Thus, a description of how the credit spread changes suggests corresponding leveraged senior loan prices that, by extension, price the embedded call option. Based on historical spread data obtained from an index such as the Standard & Poor's/Loan Syndications and Trading Association (S&P/LSTA) Leveraged Loan Index or the Credit Suisse First Boston Leveraged Loan Index, the spread process can be described by an algorithm.

The spread process can be described by an algorithm similar to one proposed by Vasicek to model short-term interest rates. Here, a stochastic differential equation in the form dr(t)=(η−γr(t))dt+νdX(t) describes both the mean reverting and the random properties of the spread process. The drift factor (η−γr(t))dt represents the expected instantaneous change in the credit spread at time t and thus depends upon the spread at the previous time interval dt. Meanwhile, the diffusion factor νdX(t) accounts for random shocks to the credit spread. A data processing system, for example, can fit equation parameters (η, γ and ν) and regulate dX with draws from a normal population.

Alternatively, the credit spread may be modeled using a two-factor model spread process based on the reference or index data of spreads. For example, in the case of a leverage loan and high-yield bond spreads, fluctuation in a market liquidity measure (e.g., average daily closing price of the VIX volatility index) and a credit risk measure (e.g., trailing 12-month Moody's Speculative Grade Default Rate) describe a large portion of credit spread change. A stochastic differential equation, including coefficients indicative of credit risk and the market liquidity parameters, is fit and used to jointly simulate credit risk and market liquidity. This approach allows near-term default and liquidity forecasts to be incorporated into the embedded call option pricing.

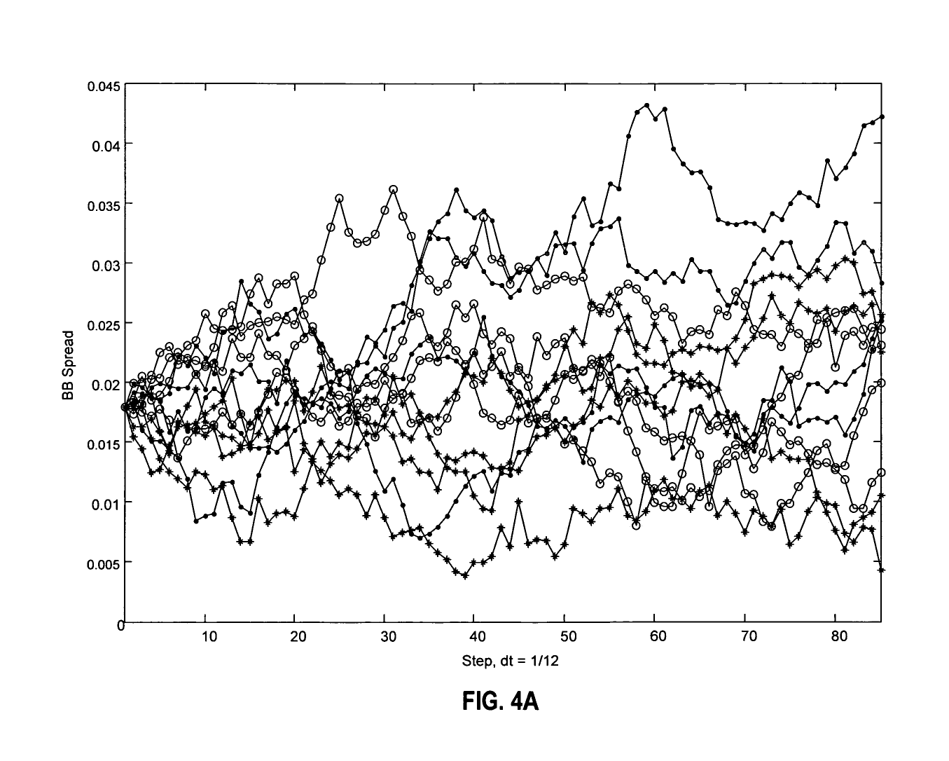

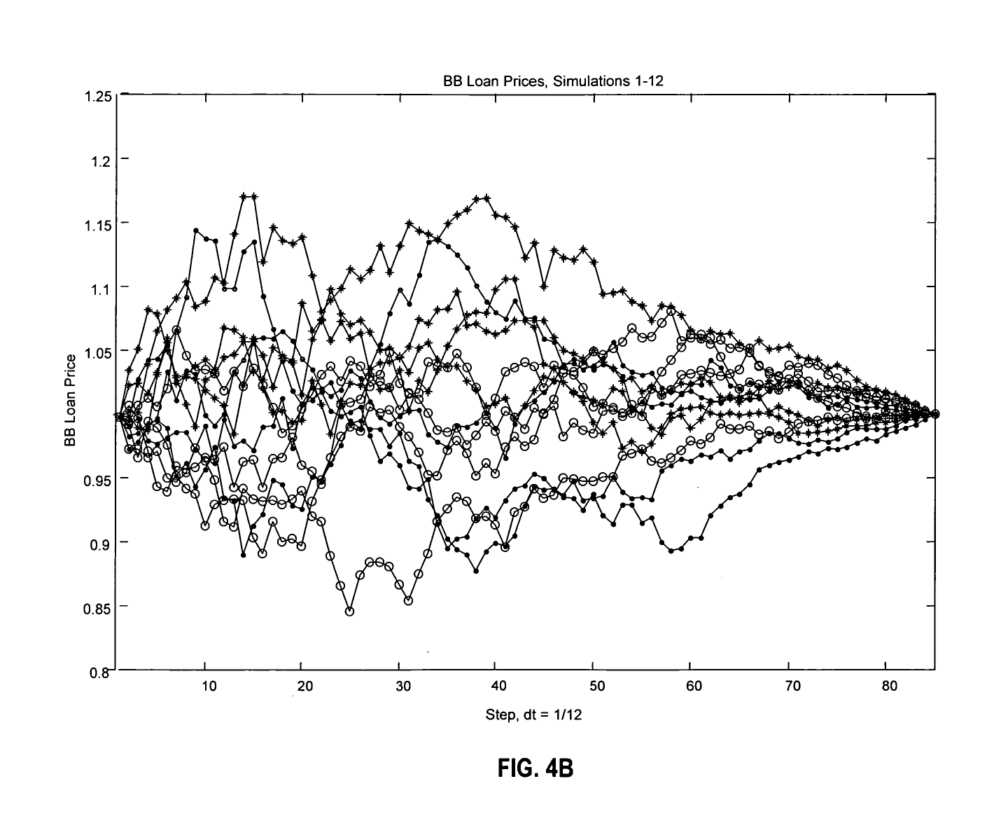

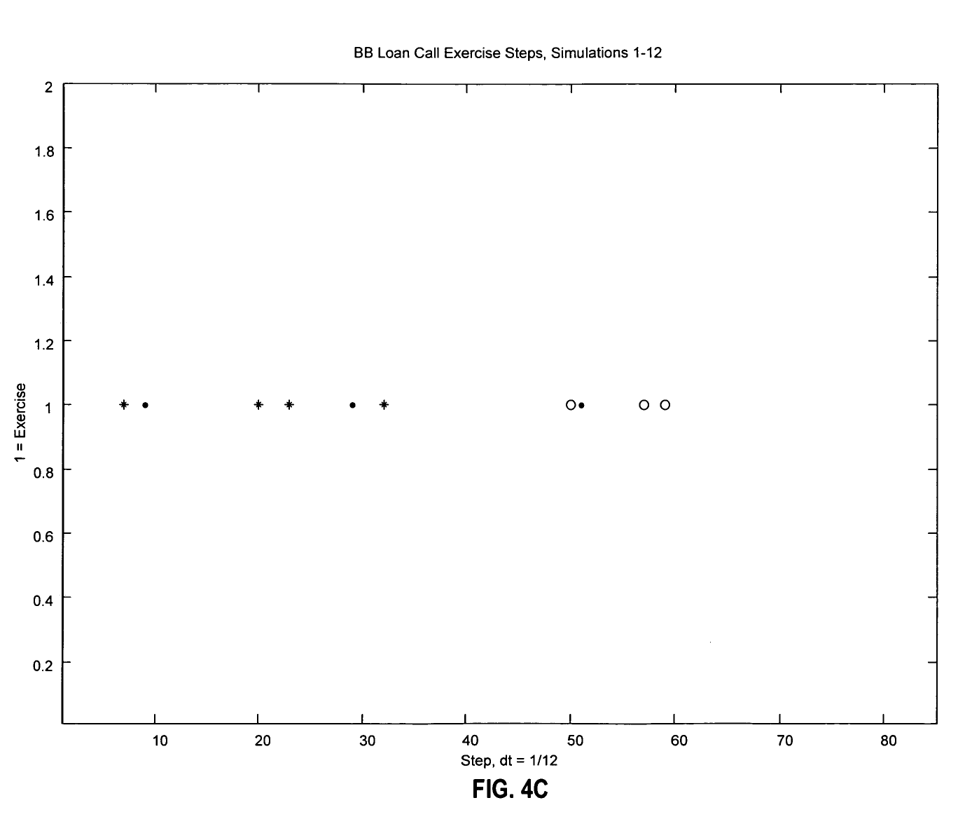

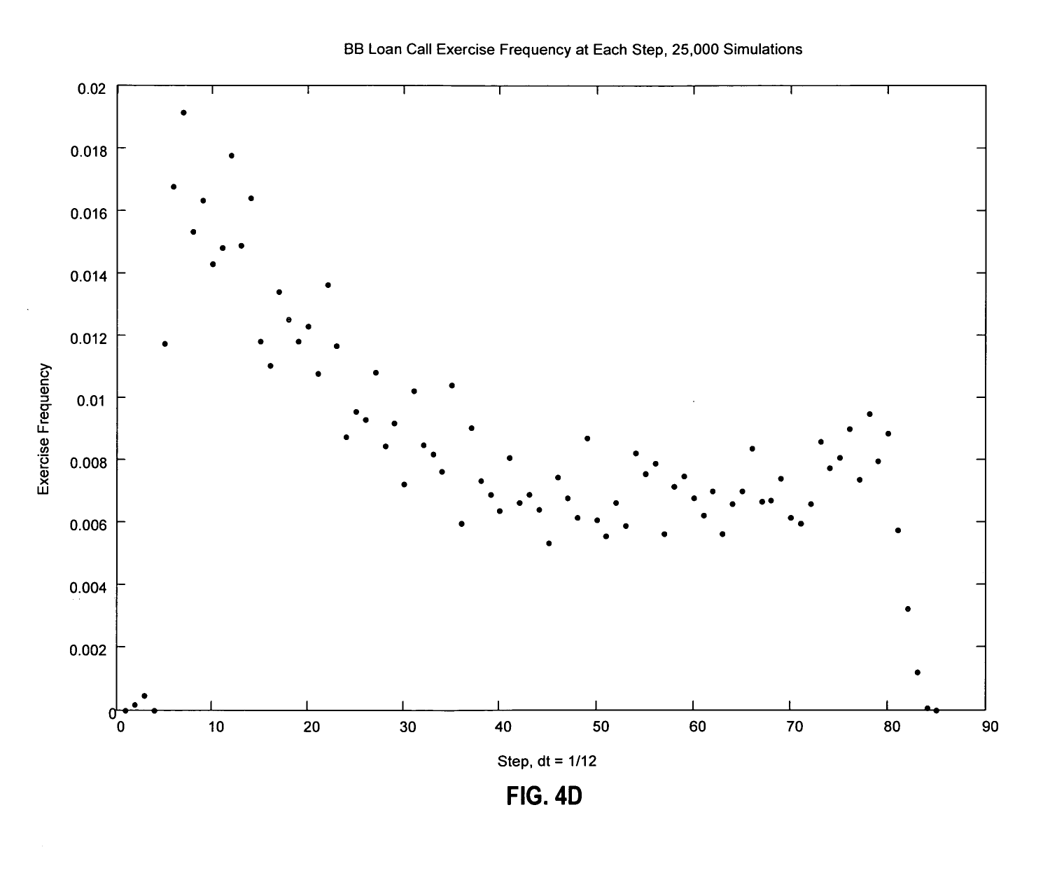

Based on the credit spread model, a large number (e.g., 25,000 or more) of possible credit spreads are simulated for the leveraged senior loan over time. (Step 205.) FIG. 4 shows exemplary credit spreads for the first twelve exemplary simulations of a BB-rated leveraged senior loan with the spread process fit from monthly data over a 10 year period, and the starting value equal to the current credit spread.

The embedded call option price is valued relative to the leveraged loan price rather than to the credit spread. Accordingly, the above-determined credit spreads are converted to prices by subtracting the prevailing market credit spread for leveraged loans of similar credit risk from the stated credit spread on the loan. (Step 210.) The market adjusts for this credit spread difference by the same convention that bond market adjusts for coupon differences; that is, by discounting to the present value at the risk-free rate, the difference at each payment date (e.g., every three months for leveraged senior loans) until maturity; this present-value of the credit-spread difference equals the premium (or discount). FIG. 4A shows an example of prices that correspond to the first twelve simulations of a BB-rated leveraged senior loan spread consistent with the process depicted in FIG. 2.

The embedded call option is determined based upon the price simulations the strike price, denoted as K, for the leveraged loan. (Step 215.) For most leveraged loans, the strike price equals the par value of the loan plus any transaction costs (e.g., refinancing) for opportunistically refinancing the loan.

The embedded option value on each path at the loan maturity period (T) equals the intrinsic value, while the option value on each path at each period before the loan maturity period (T-n) is determined based on both the intrinsic value and the continuation value of the option. Where S denotes the price of the leveraged loan, the intrinsic value at any time t equals the amount received by issuer 112 should it exercise the option at that time t. For a call, the intrinsic value equals the difference between the leveraged loan price and the strike, or (S-K). When the leveraged loan trades at 101% with a call at 100%, the intrinsic value equals 1%. Issuer 112 may choose not to exercise an option with positive intrinsic value when that option will likely have even greater intrinsic value during future periods before maturity. In other words, the holder will defer the option exercise to capture the continuation value.

Should each scenario continuation value follow from intrinsic values at subsequent periods on the same simulation path, the resulting option price would be biased towards the outcome of each simulation. Issuer 112 can estimate subsequent prices when calculating continuation values by, first, determining the intrinsic option values for all in-the-money simulations at maturity, discounting these option values one period at the risk-free rate, denoted as Y_{T-1}; second, identifying the leverage loan prices on the corresponding simulations as S_{T-1}; and, finally, determining the unbiased continuation value of the option at time T−1, denoted as Ŷ_{T-1}, relating the discounted intrinsic values to the scenario leverage loan prices by an equation. Such a formula is determined through linear regression, a technique that relates a dependent variable, Y_{T-1}, and an independent variable, S_{T-1} The best equation minimizes the average discrepancy between the actual values for the dependent variable and those values suggested by the equation. Regressing the set Y_{T-1} on the set S_{T-1} and its square, [1S_{T-1}, (S_{T-1})²], results in a more robust relationship than merely regressing Y_{T-1} on S_{T-1}. This relationship links the specific scenario leverage loan price S_{T-1} to an estimate of the corresponding continuation value of the option Ŷ_{T-1} The continuation value has no bias since it follows from an estimate rather than from the actual scenario intrinsic value on that path.

The simulation paths on which the embedded option should be exercised by issuer 112 are determined by comparing the estimated continuation values and intrinsic values for each scenario at time T−1. It is optimal to exercise the call option when the intrinsic value exceeds the continuation value or, in notational terms, when (S_{T-1}-K_{T-1})>Ŷ_{T-1} FIG. 4C illustrates exemplary times that issuer 112 may exercise the embedded call option as determined from twelve simulation paths. FIG. 4D illustrates exemplary frequencies at which issuer may exercise the embedded call option based upon 25,000 simulation paths. As shown in FIG. 4D, issuer 112 would be expected to frequently exercise the embedded option during the first few years after issuance of a leveraged loan during which changes in the spread have a greater effect on the option value and, correspondingly, the value of the leveraged loan.

On each optimal exercise path, the terminal value is set at time T−1 to (S_{T-1}-K_{T-1}) and the value at time T to zero. Repeat the option value routine for time T−2, using the terminal value on the paths exercised at time T−1 and the intrinsic value on all non-exercised paths. Repeat the option value routine for all times prior to T−2 to create, as a final product, a cash flow matrix of terminal exercise values. On each simulation, in other words, the call option either expires worthless at maturity or has some value at one of time periods, n, where (S_{T-n}-K_{T-n})>Ŷ_{T-n}. The terminal exercise values on each simulation are discounted to the present, time t, at the risk-free rate. Finally, all simulations for the embedded option value are averaged.

Based upon the value of the call option embedded in leveraged senior loans calculated above, the relative value of the leveraged loan and a corresponding LCDS can be determined. A leveraged loan and a LCDS include several features that may affect their value. However, the embedded call option is the most valuable structural difference between the two. The majority of the yield difference, called the “basis” between the leveraged loan credit spread and the LCDS premium relates to the value of the embedded call option. An investor, such investors 154 & 156, can capitalize on the difference by purchasing the cheaper of the two investments and selling short the expensive investment. In addition, an investor, such as investor 154, who may be limited to long positions, can also benefit from knowledge of the difference by purchasing outright the cheaper of the two investments.

To determine the fair value between the leveraged senior loan and LCDS investments first a “target basis” is determined by converting the lump sum embedded call option value into an annuity discounted at the risk-free rate. (Step 220.) This running payment represents the appropriate basis between the leveraged loan credit spread and the LCDS premium, given the structural difference of the call option embedded in the leveraged loan.

The “actual basis” is determined based on the difference between the leveraged senior loan spread and the LCDS premium. (Step 225.) When a leveraged senior loan is priced at par, there should be no difference between the actual basis and the target basis since LCDS premiums always assume a par notional amount. Accordingly, any discount or premium on the leveraged senior loan should correspond to the difference between the actual basis and the target basis.

When the target basis is subtracted from the actual basis and the result is converted back into a lump sum at the risk-free rate, the final fair-value discount or premium on the leveraged senior loan price results. (Step 230.) The final fair-value leveraged senior loan price is obtained by adding or subtracting the premium or discount to par (100). This fair price given the LCDS premium enables an investor in secondary market 150 to gauge relative value across both the cash leverage loan and the LCDS markets. For an investor mandated only cash leveraged loans, this information provides insight into crossover demand from the broader credit portfolio managers and perhaps some clues into the propensity of issuer 112 to exercise the embedded call option.

The credit spread implied by the leveraged loan market price, the LCDS premium and the call option value can then be determined. In a market characterized by frequent opportunistic refinancing activity and leverage loan prices above par, the current credit spread on a given leveraged loan may not provide much insight on that loan return profile. For instance, a portfolio manager who purchases a leveraged loan at 101 with a credit spread of LIBOR+2.5% may run the risk that the credit spread falls (perhaps to LIBOR+2.00%) through an opportunistic refinancing. Rather than focus upon the stated credit spread when making purchase and sale decisions, a credit portfolio manager might consider the “market-implied credit spread.”

The market implied spread is the combination of the LCDS premium, the target basis, and the basis difference implied by leveraged loan price. The combination of the LCDS premium, which compensates investors for credit risk, and the target basis, which compensates investors for the call option, should equal the fair credit spread for a leveraged loan at a par price. To the extent that leveraged loan issuer 112 does not exercise the embedded call option and “overpays” the credit spread for a period of time, investors will pay a premium for such leveraged loan. Accordingly, to determine the market-implied spread, the leveraged loan price premium is converted into a quarterly-paying annuity, discounted at the risk free rate. (Step. 235) This annuity premium represents the difference between the actual basis and the target basis implied by the value of the leveraged loans price. The market implied credit spread, or the credit spread that the market suggests that the issuer should pay, is determined by adding this annuity premium (or discount) to the LCDS premium and target basis. By adding the premium (or discount) to the leveraged loan's par value, the leveraged loan price is determined. (Step. 240.)

Although the exemplary embodiment described above is discussed with regard to valuation of embedded call options in leverage loans, the disclosed method may be used to value other financial obligations and/or financial instruments having an embedded option. For instance, the exemplary method may alternatively or additionally be used to value a put option associated with covenants included in a leveraged loan, or the like. Generally, whereas a call option is an option to buy at a predetermined price, a put option is an option to sell at a predetermined price. In the case of leveraged loans, performance-based covenants included in the loan obligation may provide investors holding rights to the loan with an embedded put option. For instance, a performance-based covenant can be a pledge made by an issuer 112 to maintain certain financial performance as measured by calculations and thresholds outlined in the loan documents. Failure to satisfy such covenants typically violates the loan terms and amounts to a borrower default. Notably, while investors could technically demand loan repayment, they typically waive the breech and reset the covenants in exchange for fees and a higher credit spread. Such covenants are essentially a “knock-in” put option in which the lenders (such as syndicators 114, primary investors 116 and secondary investors 156) can put back the loan at par (i.e. have it reset to the market coupon) after the covenant breech.

Valuing an embedded put option can follow similar procedures to the call option, described above. For this option, the credit spread process determines only the payout upon exercise. Whether or not the company violates the covenant follows from the processes on which the covenant is calculated. For example, most leveraged loan credit agreements define the leverage ratio covenant as earnings before income tax and depreciation of assets (EBITDA) divided by total debt. A simulation of the put option requires joint modeling of both the borrower EBITDA process and the debt reduction process. Finally, the put option and the payout (credit spread) processes are related.

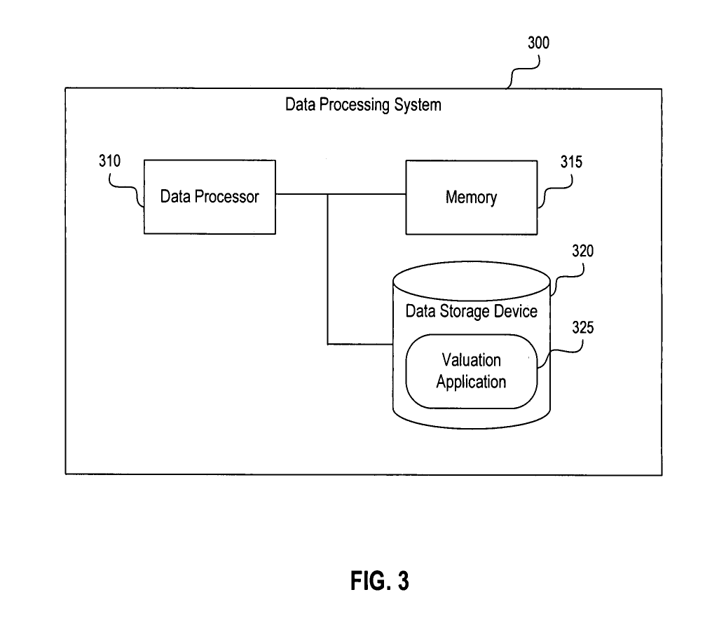

FIG. 3 is a block diagram illustrating an exemplary data processing system 300 for determining a value of an option associated with the financial obligation. Data processing system 300 may be used, for example, by brokers 152, secondary investors 154 and/or synthetic investors 156 to determine the value of a leveraged loan having an embedded call option to support decisions for buying and selling loan rights and/or LCDS contracts.

The exemplary system can include a data processing device, such as data processing system 210, and one or more data storage devices, such as data storage device 220. The one or more data storage devices can store instructions that, when executed by a data processing device, can perform a method that includes determining a target basis of the option, determining an actual basis of a derivative financial obligation corresponding to the financial obligation, and determining a current value of the financial obligation based on the difference between the target basis and actual basis.

Data processing system 300 can be implemented as one or more computer systems including, for example, a personal computer, minicomputer, microprocessor, workstation, mainframe, or any similar known computing platform employed in the art. Additionally, data processing system 310 can have components of such computing systems including, for example, a processor, memory, and data storage devices.

Data storage device 320 can store instructions that, when executed by the data processor 310, perform a method of consistent with the exemplary method disclosed above with regard to FIG. 2. Data storage device 320 can be implemented with a variety of components or subsystems including, for example, a magnetic disk drive, an optical disk drive, flash memory, or other devices capable of storing information.

As further shown in FIG. 3, data storage device 320 can store valuation application 325. Valuation application 325 can be retrieved by data processing system 300 from data storage device 320 and stored in memory 315 (e.g. RAM) for executing the application. Valuation application 325 is one or more software modules executable to value financial obligations. Financial obligation valuation application 325 can provide an interactive graphic user interface accessible users of data processing system 300 inputs, retrieve, manipulate and view information.

As disclosed herein, embodiments and features can be implemented through computer hardware and/or software. Such embodiments can be implemented in various environments, such as networked and computing-based environments with one or more users. The present invention, however, is not limited to such examples, and embodiments can be implemented with other platforms and in other environments.

Moreover, while illustrative embodiments have been described herein, further embodiments can include equivalent elements, modifications, omissions, combinations (e.g., of aspects across various embodiments), adaptations and/or alterations as would be appreciated by those in the art based on the present disclosure.

Other embodiments of the invention will be apparent to those skilled in the art from consideration of the specification and practice of the embodiments of the invention disclosed herein. Further, the steps of the disclosed methods can be modified in any manner, including by reordering steps and/or inserting or deleting steps, without departing from the principles of the invention. It is therefore intended that the specification and embodiments be considered as exemplary only.

1. A method for valuing a financial obligation having an embedded option, comprising:
determining a value of the embedded option;
converting the embedded option value to a target basis representing the yield difference between the financial obligation having the embedded option and a corresponding financial instrument without an embedded option;
determining an actual basis between the financial obligation and the corresponding financial instrument;
determining a current value of the financial obligation based on the difference between the target basis and the actual basis.

2. The method of claim 1, wherein determining the value of the embedded call option includes:
determining a spread process;
simulating spreads using the spread process; and
determining call option value based on the simulated spreads.

3. The method of claim 1, wherein determining a current value of the financial obligation includes:
annuitizing the difference between the target basis and the actual basis.

4. The method of claim 1, wherein the financial obligation is a leveraged loan and the financial instrument is a loan-only default swap corresponding to the leveraged loan.

5. The method of claim 1, wherein the option is a right to repay the loan before a maturity date of the loan.

6. The method of claim 1, wherein the option is a right to demand payment of the loan before a maturity date of the loan.

7. A computer-readable medium storing instructions that, when executed by a data processor, perform a method for valuing a financial obligation having an embedded option, comprising:
determining a value of the embedded option;
converting the embedded option value to a target basis representing the yield difference between the financial obligation having the embedded option and a corresponding financial instrument without an embedded option;
determining an actual basis between the financial obligation and the corresponding financial instrument;
determining a current value of the financial obligation based on the difference between the target basis and the actual basis.

8. The computer-readable medium of claim 7, wherein determining the value of the embedded call option includes:
determining a spread process;
simulating spreads using the spread process; and
determining call option value based on the simulated spreads.

9. The computer-readable medium of claim 7, wherein determining a current value of the financial obligation includes:
annuitizing the difference between the target basis and the actual basis.

10. The computer-readable medium of claim 7, wherein the financial obligation is a leveraged loan and the financial instrument is a loan-only default swap corresponding to the leveraged loan.

11. The computer-readable medium of claim 7, wherein the option is a right to repay the loan before a maturity date of the loan.

12. The computer-readable medium of claim 7, wherein the option is a right to demand payment of the loan before a maturity date of the loan.

13. A system for valuing a financial obligation having an embedded option, the system comprising a data processor and a computer-readable storage medium including computer-readable instructions that, when executed by the data processor, perform a method including:
determining a value of the embedded option;
converting the embedded option value to a target basis representing the yield difference between the financial obligation having the embedded option and a corresponding financial instrument without an embedded option;
determining an actual basis between the financial obligation and the corresponding financial instrument;
determining a current value of the financial obligation based on the difference between the target basis and the actual basis.

14. The system of claim 13, wherein determining the value of the embedded call option includes:
determining a spread process;
simulating spreads using the spread process; and
determining call option value based on the simulated spreads.

15. The system of claim 13, wherein determining a current value of the financial obligation includes:
annuitizing the difference between the target basis and the actual basis.

16. The system of claim 13, wherein the financial obligation is a leveraged loan and the financial instrument is a loan-only default swap corresponding to the leveraged loan.

17. The system of claim 13, wherein the option is a right to repay the loan before a maturity date of the loan.

18. The system of claim 13, wherein the option is a right to demand payment of the loan before a maturity date of the loan.
